(19) United States
(12) Patent Application Publication
(10) Pub. No.: US 2022/0190658 A1
(43) Pub. Date: Jun. 16, 2022

(54) ROTOR FOR AN ELECTRICAL MACHINE HAVING ASYMMETRIC POLES AND LATERAL MAGNETS

(71) Applicant: IFP Energies nouvelles, RUEIL-MALMAISON CEDEX (FR)

(72) Inventors: Abdenour ABDELLI, RUEIL-MALMAISON CEDEX (FR); Benjamin GAUSSENS, RUEIL-MALMAISON CEDEX (FR); Andre NASR, RUEIL-MALMAISON CEDEX (FR); Baptiste CHAREYRON, RUEIL-MALMAISON CEDEX (FR)

(21) Appl. No.: 17/598,370

(22) PCT Filed: Mar. 17, 2020
(86) PCT No.: PCT/EP2020/057284

§ 371 Date: Sep. 27, 2021

(30) Foreign Application Priority Data
Mar. 29, 2019 (FR) FR1903418

(51) Int. Cl. H02K 1/276

(52) U.S. Cl. CPC H02K 1/2766; H02K 29/03

(57) ABSTRACT

The present invention is a rotor (1) for an electrical machine featuring magnetic poles with asymmetric flux barriers (9, 10, 11). Additionally, lateral magnets (20) are provided in at least one flux barrier (9, 10, 11) of each pole.

### CROSS-REFERENCE TO RELATED APPLICATIONS

Reference is made to PCT/EP2020/057284 filed Mar. 17, 2020, and French Patent Application No. 1903418 filed Mar. 29, 2019, which are incorporated herein by reference in their entirety.

### BACKGROUND OF THE INVENTION

### Field of the Invention

The present invention relates to a (permanent-magnet-assisted) synchronous reluctance rotary electrical machine, and relates more particularly to a rotor of such a machine which operates with a high-voltage DC bus and which allows a high rotational speed.

### Description of the Prior Art

Generally, such an electrical machine includes a rotor and a stator arranged coaxially one inside the other.

The rotor is formed of a rotor body with a stack of laminations placed on a rotor shaft. These laminations comprise housings for permanent magnets and perforations for creating flux barriers for radially directing the magnetic flux from the magnets towards the stator and to promote the creation of a reluctance torque.

The rotor is housed inside a stator which bears electrical windings for generating a magnetic field to rotate the rotor.

As is better described in patent application WO2016188764, the rotor of such an electrical machine comprises axial voids which pass through the laminations from one side to the other.

A first series of axial voids, arranged radially one above the other and at a distance from one another, form housings for magnetic flux generators which in this case are permanent magnets in the form of a rectangular bar.

An other series of voids have perforations in an inclined radial direction which start from the housings and end in the vicinity of the edge of the laminations, in the vicinity of the air gap.

The inclined perforations are arranged symmetrically in relation to the housings for the magnets to form a geometric figure in each instance that is substantially in the shape of a flat-bottomed V with the flat bottom being formed by the housing for the magnets and with the inclined arms of this V being formed by the perforations. This creates flux barriers formed by the perforations. The magnetic flux emanating from the magnets can then pass only through the solid portions between the perforations. These solid portions are a ferromagnetic material.

However, it has been observed that the counter-electromotive force harmonics and torque ripple are substantial in this type of permanent-magnet-assisted synchronous reluctance machine.

This can generate jolts and vibrations in the rotor, resulting in discomfort when using this machine.

The French patent application number FR 1758621 describes an electrical machine that alleviates these drawbacks by virtue of an asymmetric structure for the magnetic poles of the rotor. However, it is desirable to improve the performance of the electrical machine described in this patent application still further, in particular in terms of torque at low speed and of maximum power.

### SUMMARY OF THE INVENTION

To improve the performance of the electrical machine while limiting torque ripple which causes jolts and vibrations in the rotor, the present invention is a rotor for an electrical machine featuring magnetic poles with asymmetric flux barriers. Additionally, lateral magnets are provided in at least one flux barrier of each pole, making it possible in particular to increase the torque at low speed and the maximum power by increasing the weight of magnets within the rotor.

The invention also relates to an electrical machine, in particular a synchronous reluctance electrical machine, comprising such a rotor.

The invention relates to a rotor for an electrical machine comprising:
a rotor body, formed by a stack of laminations, which is preferably placed on a rotor shaft;
N pairs of magnetic poles, each magnetic pole including at least three magnets which are positioned in axial voids; and
three asymmetric flux barriers which form each magnetic pole, that include one outer flux barrier, one center flux barrier and one inner flux barrier, each flux barrier comprising two inclined voids that are positioned on either side of each axial void, the two inclined voids forming an opening angle between them which corresponds to the angle between two straight lines each passing through the center of the rotor and through a midpoint positioned on an outer face of the respective voids of each flux barrier.

The rotor comprises:
magnets in the inclined voids of at least one flux barrier of each magnetic pole;
N primary magnetic poles each including an inner flux barrier comprising an opening angle (θ1), a center flux barrier comprising an opening angle (θ2) and an outer flux barrier comprising an opening angle (θ3), such that the opening angles (θ1, θ2, θ3) satisfy at least two of the following three equations: θ1=(0.946+/0.014)×P, θ2=(0.711+/0.014)×P, θ3=(0.508+/0.014)×P;
N secondary magnetic poles each composed of an inner flux barrier comprising an opening angle (θ1), a centre flux barrier comprising an opening angle (θ2) and an outer flux barrier comprising an opening angle (θ3), such that the opening angles (θ1, θ2, θ3) satisfy at least two of the three equations: θ1=(0.776+/0.014)×P, θ2=(0.564+/0.014)×P, θ3=(0.348+/0.014)×P, each secondary pole alternating with a primary pole wherein
P is the pole pitch of the rotor defined in degrees by

$$P = \frac{360}{2 \times N} .$$

Advantageously, the number N of pairs of magnetic poles is between 2 and 9, preferably between 3 and 6, and most preferably equals 5.

Preferably, the flux barriers are substantially shaped as a flat-bottomed V.

According to one embodiment, the rotor comprises magnets in the inclined voids of the inner and center flux barriers.

Advantageously, the dimensions of the magnets in the inclined voids of the center flux barriers are identical to the dimensions of the magnets in the outer axial voids.

According to one aspect of the invention, the dimensions of the magnets in the inclined voids of the inner flux barriers are identical to the dimensions of the magnets in the center axial voids.

According to one implementation, the opening angles (θ1, θ2, θ3) of the primary magnetic poles satisfy at least two of the following three equations: θ1=(0.946+/0.008)×P, θ2=(0.711+/0.008)×P, θ3=(0.348+/0.008)×P.

According to one aspect, the opening angles (θ1, θ2, θ3) of the secondary magnetic poles satisfy at least two of the following three equations: θ1=(0.776+/0.008)×P, θ2=(0.564+10.008)×P, θ3=(0.348+/0.008)×P.

According to one embodiment, the opening angles (θ1, θ2, θ3) of the primary magnetic poles satisfy the three equations.

According to one aspect of the invention, the opening angles (θ1, θ2, θ3) of the secondary magnetic poles satisfy the three equations.

Additionally, the invention relates to an electrical machine comprising a stator and a rotor according to one of the preceding features, the rotor being housed inside the stator.

According to one implementation of the invention, the stator comprises radial slots that are arranged circumferentially around the stator with the number of slots preferably being six times the number N of pole pairs of the rotor.

Advantageously, the slots extend axially along the stator.

According to one aspect, the electrical machine is a synchronous reluctance electrical machine.

### BRIEF DESCRIPTION OF THE DRAWINGS

Other features and advantages of the device according to the invention will become apparent upon reading the following description of non-limiting exemplary embodiments with reference to the appended figures described herein:

FIG. 1 illustrates a rotor according to one embodiment of the invention with the rotor comprising five pole pairs.

FIG. 2 illustrates an electrical machine featuring five pole pairs according to one embodiment of the invention.

FIG. 3 is a comparative curve of the torque with rotational speed of the rotor for an example of an electrical machine according to the invention and of an electrical machine according to an example which is not in accordance with the invention.

FIG. 4 is a comparative curve of the power with rotational speed of the rotor for an example of an electrical machine according to the invention and of an electrical machine according to an example which is not in accordance with the invention.

FIG. 5 is a comparative curve of torque with current for an example of an electrical machine according to the invention and of an electrical machine according to an example which is not in accordance with the invention.

FIG. 6 is a comparative curve of power with rotational speed of the rotor of an example of an electrical machine according to the invention and of an electrical machine according to an example which is not in accordance with the invention with the same initial current.

### DETAILED DESCRIPTION OF THE INVENTION

The present invention relates to a rotor for an electrical machine and in particular to a synchronous reluctance electrical machine. Additionally, the present invention relates to an electrical machine comprising a rotor according to the invention and a stator in which the rotor is arranged within the stator to be coaxially in relation to the stator.

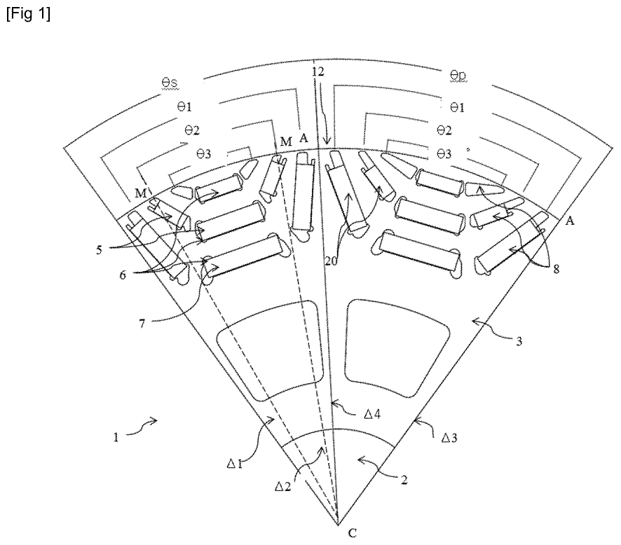

As illustrated in FIG. 1 (non-limitingly FIG. 1 is a partial view of the rotor corresponding to a pair of magnetic poles), rotor 1 includes, in a manner known per se, preferably a magnetic, shaft 2 on which a stack of laminations 3 is mounted. In the context of the invention, these laminations 3 are ferromagnetic, planar, identical, laminated and circular in shape, and are joined together by any known means. The laminations 3 may comprise a central bore through which the rotor shaft 2 passes and axial voids 5 which pass all the way through the laminations 3.

A first series of axial voids 6, which is arranged radially one above the other and at a distance from one another, form housings for magnetic flux generators, which in this case are permanent magnets 7 in the form of a bar. The axial voids 6 are substantially trapezium-shaped. However, the axial voids 6 may take other shapes, in particular rectangular, square, etc. shapes.

A second series of voids has perforations extending in a direction 8 that is inclined relative to the radial direction, which start from the axial voids 6 and end in a vicinity of the edge of the laminations 3, that is at an air gap of the electrical machine.

The inclined perforations 8 are arranged symmetrically in relation to the voids 6 containing the magnets 7 so as to form a geometric figure which in each instance is substantially shaped as a flat-bottomed V with the flat bottom being formed by the housing 6 for the magnets 7 and with inclined arms of the V being formed by the inclined perforations 8. The inclined perforations 8 form flux barriers. The magnetic flux emanating from the magnets 7 can then pass only through the solid portions of the laminations 3 between the voids. These solid portions are a ferromagnetic material.

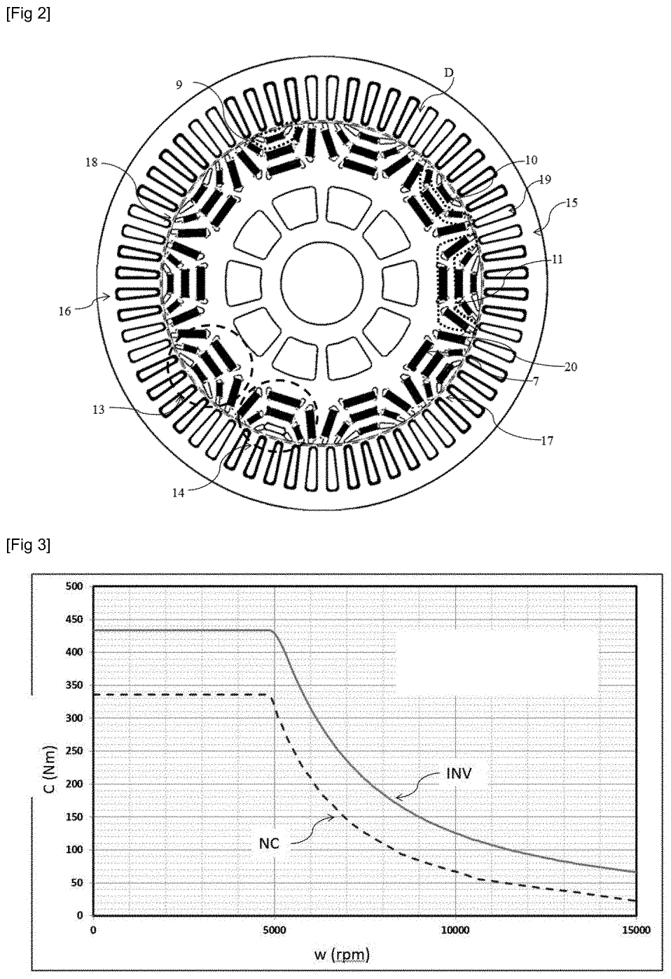

According to the invention, the rotor comprises N pairs of magnetic poles (or 2×N magnetic poles) with a magnetic pole being formed by the three voids 6 for the magnets in the same radial direction, and the associated flux barriers 9, 10, 11 shown in FIG. 2. Advantageously, N may be between 2 and 9, and N is preferably between 3 and 6, and is most preferably equal to 5.

From the number N of pole pairs, a pole pitch P is defined. Expressed in degrees, the pole pitch may be determined by a formula such as:

$$P = \frac{360}{2 \times N}$$

For the example illustrated in FIGS. 1 and 2, the rotor 1 comprises ten magnetic poles (N=5) in which the value of the pole pitch P is therefore 36°. Each magnetic pole has three permanent magnets 7 which are positioned in the three axial voids 6 provided to house the permanent magnets 7. The rotor 1 also has three flux barriers, which include one outer flux barrier 9 associated with the outer void 6, that is closest to the periphery of the rotor 1, one center flux barrier 10 associated with the center void 6 and one inner flux barrier 11 associated with the inner void 6, that is closest to the center of the rotor 1.

As can be seen in FIGS. 1 and 2, each flux barrier (9, 10, 11) comprises two inclined perforations which are arranged symmetrically in relation to the housings for the magnets 7 for each magnetic pole. Thus, a geometric figure is formed in each instance which is substantially in the shape of a flat-bottomed V with the flat bottom being formed by the housing 7 and with the inclined arms of this V being formed by the inclined perforations. For each flux barrier 9, 10, 11 of each magnetic pole, there will be a corresponding opening angle θ1, θ2, θ3 which qualifies the opening of the V shape. These opening angles correspond to the angle between two straight lines 41, 42 each passing through the center C of the rotor 1 and through a midpoint M positioned on an outer face 12 (advantageously on the radius of the air gap located halfway between the rotor and the stator) of the perforations in an inclined radial direction 8 of each flux barrier. The outer face 12 is located on the periphery of the rotor 1 at a mechanical air gap of the electrical machine as seen in the description below.

In the context of the invention, the rotor 1 comprises two distinct magnetic-pole architectures. For this, it comprises N primary magnetic poles 13 and N secondary magnetic poles 14. The rotor includes alternating primary magnetic poles 13 and secondary magnetic poles 14. For the examples of FIGS. 1 and 2, the rotor 1 comprises five primary magnetic poles 13 and five secondary magnetic poles 14.

According to the invention, the N primary magnetic poles 13 each has an inner flux barrier 11 which comprises an opening angle θ1, a center flux barrier 10 comprising an opening angle θ2 and an outer flux barrier 9 comprising an opening angle θ3. The angles θ1, θ2 and θ3 of the primary magnetic poles satisfy at least two of the following three equations: θ1=(0.946+/0.014)×P, θ2=(0.711+/0.014)×P, θ3=(0.508+/0.014)×angles P. Regarding the N secondary magnetic poles 14, they each have an inner flux barrier 11 comprising an opening angle θ1, a center flux barrier 10 comprising an opening angle θ2 and an outer flux barrier 9 comprising an opening angle θ3. The angles θ1, θ2 and θ3 of the primary magnetic poles satisfy at least two of the following three equations: θ1=(0.776+/0.014)×P, θ2=(0.564+/0.014)×P, θ3=(0.348+/0.014)×P.

In the present application, X+/−Y (where X and Y are positive numbers) means a range centred on the value X, which range is between the values X-Y and X+Y.

It should be noted that while two of the three angles of a pole are restricted by equations, the third is also restricted by rotor structure which is in particular by the pole pitch (maximum opening angle), by the other opening angles (in particular, the opening angle of the inner barrier is larger than the center opening angle, which is itself larger than the opening angle of the outer barrier), and by the symmetry of the flux barriers within a pole. Thus, restricting two angles out of three using equations is sufficient to obtain the desired effects in terms of decreased torque ripple and harmonics.

A major aspect of the invention is that the rotor 1 comprises alternating primary magnetic poles 13 and secondary magnetic poles 14. In this way, torque ripple, counter-electromotive force harmonics and acoustic noise are substantially decreased with respect to the electrical machine of the prior art, while torque is maximized.

Specifically, asymmetric flux barriers are thus created between two consecutive poles. The magnetic flux from the magnets can then pass only through the solid portions between the perforations which results in torque ripple, counter-electromotive force harmonics and acoustic noise being decreased.

According to one embodiment option of the invention, the opening angles θ1, θ2 and θ3 of the primary magnetic poles 13 satisfy at least two of the following three equations: θ1=(0.946+/0.008)×P, θ2=(0.711+/0.008)×P, θ3=(0.508+/10.008)×P. This embodiment option makes it possible to optimize the decrease in torque ripple and the decrease in harmonics.

According to another embodiment option of the invention (which may be combined with the preceding option), the opening angles 01, 02 and 03 of the secondary magnetic poles 14 satisfy at least two of the following three equations: θ1=(0.776+/0.008)×P, θ2=(0.564+/0.008)×P, θ3=(0.348+/0.008)×P. This embodiment option makes it possible to optimize the decrease in torque ripple and the decrease in harmonics.

Preferably, the opening angles θ1, θ2 and θ3 of the primary magnetic poles 13 satisfy the three equations presented below (that is either the equations according to the invention, or the equations according to one embodiment option). This embodiment makes it possible to optimize the decrease in torque ripple and the decrease in harmonics.

Preferably, the opening angles θ1, θ2 and θ3 of the secondary magnetic poles 14 satisfy the three equations (that is either the equations according to the invention, or the equations according to one embodiment option). This embodiment makes it possible to optimize the decrease in torque ripple and the decrease in harmonics.

Thus, according to one preferred implementation, the N primary magnetic poles 13 are each have an inner flux barrier 11 which comprises an opening angle θ1 substantially equal to (0.946+/−0.008)×P, a center flux barrier 10 comprising an opening angle θ2 substantially equal to (0.711+/−0.008)×P and an outer flux barrier 9 comprising an opening angle θ3 substantially equal to (0.508+/−0.008)×P. The N secondary magnetic poles 14 each have an inner flux barrier 11 comprising an opening angle θ1 substantially equal to (0.776+/−0.008)×P, a center flux barrier 10 comprising an opening angle θ2 substantially equal to (0.564+/−0.008)×P and an outer flux barrier 9 comprising an opening angle θ3 substantially equal to (0.348+/−0.008)×P. This preferred implementation allows a solution that is optimal in terms of decreasing torque ripple and decreasing harmonics.

For the embodiment of FIGS. 1 and 2 for which N=5, hence P=36°, the five primary magnetic poles 13 each have an inner flux barrier 11 comprising an opening angle θ1 substantially equal to 34.05°, a center flux barrier 10 comprising an opening angle θ2 substantially equal to 25.58° and an outer flux barrier 9 comprising an opening angle θ3 substantially equal to 18.29°. The four secondary magnetic poles 14 each have an inner flux barrier 11 comprising an opening angle θ1 substantially equal to 27.93°, a center flux barrier 10 comprising an opening angle θ2 substantially equal to 20.32° and an outer flux barrier 9 comprising an opening angle θ3 substantially equal to 12.51°.

Additionally, for the embodiment of FIGS. 1 and 2 for which N=5, the value of the opening angle for the primary magnetic pole θp is 39°, and the value of the opening angle for the secondary magnetic pole θs is 33°. The opening angle of a magnetic pole is defined as the angle between two straight lines (43, 44) each passing through the center C of the rotor 1 and through a midpoint A positioned on an outer face 12 between each primary pole 13 and each secondary pole 14. For this embodiment, the six opening angles (θ1, θ2 and θ3 of the primary and secondary magnetic poles) belong to the preferred implementation of the invention.

Generally speaking, according to one aspect of the invention, the opening angle of the primary magnetic pole θp may be substantially equal to 1.083×P+/−0.5°, and the opening angle of the secondary magnetic pole θs may be substantially equal to 0.917×P+/0.5°.

The decrease in torque ripple, counter-electromotive force harmonics and acoustic noise is further obtained because of the definition of the angles of the primary and secondary magnetic poles according to the invention with respect to asymmetric design for the electrical machine. This asymmetric design may, for example (in the case of an electrical machine with eight poles), substantially correspond to the design described in the French patent application number 17/58.621.

Additionally, according to the invention, magnets 20 are provided in the inclined voids 8 of at least one flux barrier 9, 10 or 11 of each magnetic pole. In other words, at least one flux barrier 9, 10 or 11 of each magnetic pole includes lateral magnets 20. Thus, the weight of magnets within the rotor is increased, which allows the performance of the electrical machine to be improved, in particular for the torque at low speed and the maximum power.

According to one embodiment of the invention, the rotor may comprise lateral magnets 20 only in the inclined voids 8 of the inner flux barriers 11 with no lateral magnet being provided in the inclined voids 8 of the center 10 and outer 9 flux barriers.

Preferably, the rotor may comprise lateral magnets 20 only in the inclined voids 8 of the inner 11 and center 10 flux barriers with no lateral magnet being provided in the inclined voids of the outer flux barriers. This configuration makes it possible to optimize the weight of the magnets within the rotor and the performance of the electrical machine.

For these two embodiments, the dimensions of the lateral magnets 20 positioned in the voids 8 of the inner flux barriers 11 may be identical to those of the axial magnets 7 positioned in the center axial voids 6 (corresponding to the center flux barriers 10). Thus, the number of different magnets used is limited, allowing the cost of the rotor to be decreased.

For the preferred embodiment, the dimensions of the lateral magnets 20 positioned in the voids 8 of the center flux barriers 10 may be different from those of the axial magnets 7 arranged in the outer axial voids 6 (corresponding to the outer flux barriers 9). Torque at low speed is thus maximized.

The non-limiting example of FIGS. 1 and 2 corresponds to the preferred embodiment of the invention, for which lateral magnets 20 are positioned in the voids 8 of the inner 11 and center 10 flux barriers, and for which the dimensions of the lateral magnets 20 positioned in the voids 8 of the inner flux barriers 11 are identical to those of the axial magnets 7 positioned in the center axial voids 6, and for which the dimensions of the lateral magnets 20 positioned in the voids 8 of the center flux barriers 10 are different from those of the axial magnets 7 positioned in the outer axial voids 6.

According to one embodiment option of the invention, the magnets are low-cost magnets such as ferrite, AlNiCo, etc. magnets. Thus, the cost of the rotor is low despite the number of permanent magnets positioned within the rotor.

Thus, the rotor according to the invention is suitable for a synchronous reluctance electrical machine which operates with a high-voltage DC bus which allows a high rotational speed (higher than 15 000 rpm, for example than 18 000 rpm).

Table 1 gives, in non-limitingly manner, the values of the angles θ1, θ2 and θ3 for different values of N according to the invention.

TABLE 1

| | | N | | | |
|---|---|---|---|---|---|
| | | 3 | 4 | 5 | 6 |
| | | P | | | |
| | | 60° | 45° | 36° | 30° |
| Secondary | θ3 | 20.88° +/− | 15.66° +/− | 12.53° +/− | 10.44° +/− |
| magnetic | | 0.83° | 0.63° | 0.50° | 0.42° |
| pole 14 | θ2 | 33.84° +/− | 25.38° +/− | 20.30° +/− | 16.92° +/− |
| | | 0.83° | 0.63° | 0.50° | 0.42° |
| | θ1 | 46.56° +/− | 34.92° +/− | 27.94° +/− | 23.28° +/− |
| | | 0.83° | 0.63° | 0.50° | 0.42° |
| Primary | θ3 | 30.48° +/− | 22.86° +/− | 18.29° +/− | 15.24° +/− |
| magnetic | | 0.83° | 0.63° | 0.50° | 0.42° |
| pole 13 | θ2 | 42.66° +/− | 32.00° +/− | 25.60° +/− | 21.33° +/− |
| | | 0.83° | 0.63° | 0.50° | 0.42° |
| | θ1 | 56.76° +/− | 42.57° +/− | 34.06° +/− | 28.38° +/− |
| | | 0.83° | 0.63° | 0.50° | 0.42° |

Table 2 gives, in non-limitingly manner, the values of the angles θ1, θ2 and θ3 for different values of N according to the preferred implementation of the invention.

TABLE 2

| | | N | | | |
|---|---|---|---|---|---|
| | | 3 | 4 | 5 | 6 |
| | | P | | | |
| | | 60° | 45° | 36° | 30° |
| Secondary | θ3 | 20.88° +/− | 15.66° +/− | 12.53° +/− | 10.44° +/− |
| magnetic | | 0.48° | 0.36° | 0.29° | 0.24° |
| pole 14 | θ2 | 33.84° +/− | 25.38° +/− | 20.30° +/− | 16.92° +/− |
| | | 0.48° | 0.36° | 0.29° | 0.24° |
| | θ1 | 46.56° +/− | 34.92° +/− | 27.94° +/− | 23.28° +/− |
| | | 0.48° | 0.36° | 0.29° | 0.24° |
| Primary | θ3 | 30.48° +/− | 22.86° +/− | 18.29° +/− | 15.24° +/− |
| magnetic | | 0.48° | 0.36° | 0.29° | 0.24° |
| pole 13 | θ2 | 42.66° +/− | 32.00° +/− | 25.60° +/− | 21.33° +/− |
| | | 0.48° | 0.36° | 0.29° | 0.24° |
| | θ1 | 56.76° +/− | 42.57° +/− | 34.06° +/− | 28.38° +/− |
| | | 0.48° | 0.36° | 0.29° | 0.24° |

According to one implementation of the invention, the length of the rotor 1 may be 200 mm, and the laminations 3 making up the rotor 1 may be 0.35 mm laminations. However, these values are in no way limiting and all ranges of distances which comply with the angle values mentioned above are possible.

As can be seen in FIG. 2, which schematically illustrates, in a non-limitingly manner, a rotary electrical machine in accordance with one embodiment of the invention (in this case a permanent-magnet-assisted variable-reluctance synchronous machine), the electrical machine also comprises a stator 15 which is fitted coaxially in relation to the rotor 1.

The stator 15 comprises an annular ring 16 with an inner wall 17 with the inner diameter of which being designed to accommodate the rotor 1 with a space required for forming an air gap 18. This ring comprises slots (piercings), in this case of oblong section, which form slots 19 for the armature windings.

More specifically, these piercings extend axially all the way along the stator 15 by being arranged radially over the ring while being positioned circumferentially away from each other by a distance D. The number of slots is predetermined according to the characteristics of the electrical machine, and according to the number N of pole pairs. Preferably, the number of slots in the stator may correspond to four times the number N of pole pairs of the rotor multiplied by the number of phases of the stator. For the example illustrated in FIG. 2, for which N=5 and for which the stator includes three phases, there are 60 slots.

According to one embodiment example, the outer diameter of the stator may be between 100 and 300 mm, and preferably about 200 mm, and the inner diameter thereof may be between 50 and 200 mm, preferably about 157.4 mm. The length of the air gap 18 of the electrical machine may be between 0.4 and 0.8 mm, preferably between 0.5 and 0.6 mm.

The synchronous reluctance electrical machine according to the invention is particularly suitable for application in an electrical powertrain.

However, the electrical machine according to the invention may be used in any stationary or mobile application type.

The invention is not limited to just these embodiments of the voids described above by way of example, but rather encompasses all variants.

### EXAMPLES

The features and advantages of the method according to the invention will become more clearly apparent on reading about the following example of application.

In this example, a synchronous reluctance electrical machine according to the invention, according to the embodiment of FIG. 2, with N=5 and with lateral magnets in the voids of the inner and center flux barriers in each magnetic pole, is compared with an electrical machine which is not in accordance with the invention, which is without lateral magnets. The electrical machine not in accordance with the invention exhibits the same features as the electrical machine according to the invention, in particular the same number of pole pairs, the same dimensions and the same opening angles for the flux barriers. The only difference between the two electrical machines is the presence of lateral magnets in the electrical machine according to the invention.

For this example, the magnet volume for these two electric-machine designs is first compared in Table 2.

TABLE 2

| | Example which is not | Example which is |
|---|---|---|
| | in accordance with | according to |
| | the invention | the invention |
| Magnet volume (cm³) | 106.31 | 214.15 |
| Difference (%) | 0 | 101 |

Thus, the rotor according to the invention makes it possible to double the volume and hence the weight, of magnets within the electrical machine, which increases the performance of the electrical machine as illustrated in FIGS. 3 to 6.

FIG. 3 is a curve of the torque C in Nm with rotational speed w of the rotor in rpm, for the electrical machine according to the invention INV and for the electrical machine which is not in accordance with the invention NC with the same maximum current I in A in the electrical machine.

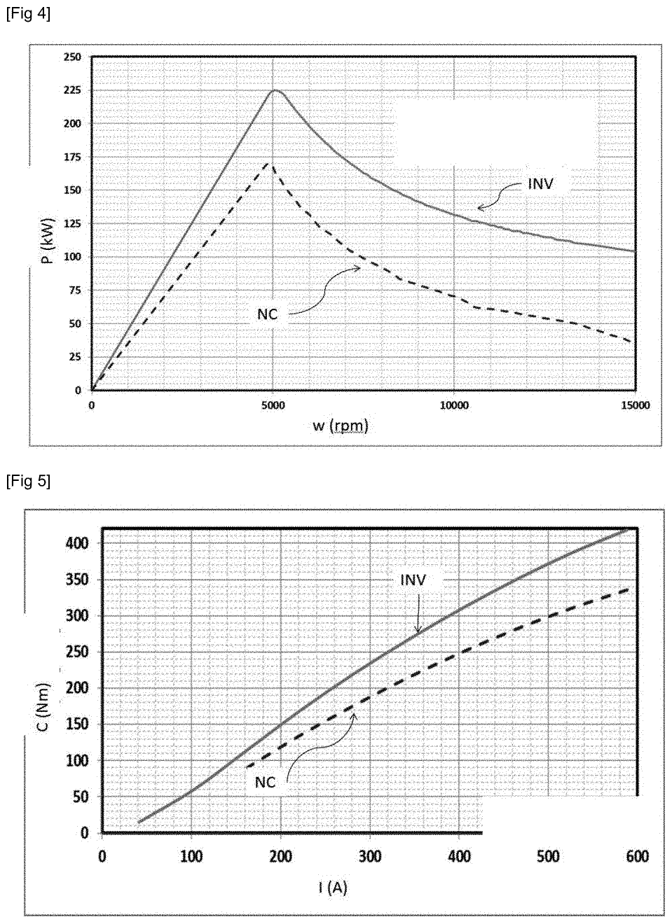

FIG. 4 is a curve of the power P in kW with rotational speed w of the rotor in rpm, for the electrical machine according to the invention INV and for the electrical machine which is not in accordance with the invention NC with the same maximum current I in A in the electrical machine.

It can be seen in FIGS. 3 and 4 that the electrical machine according to the invention INV allows the torque at low speed to be increased by 25% and the maximum power to be increased by 32% with respect to the electrical machine which is not in accordance with the invention NC. Additionally, it can be seen that the gain at high speed is even higher and allows the torque and power to be doubled.

FIG. 5 is a curve of the torque C in Nm with current I in A injected into the electrical machine, for the electrical machine according to the invention INV and for the electrical machine which is not in accordance with the invention NC.

It can be seen that the electrical machine according to the invention INV makes it possible, at constant torque, to have a lower current requirement through the addition of lateral magnets with respect to the electrical machine which is not in accordance with the invention NC. In this way, for the same torque and in the context of the invention, the maximum current is decreased by 25% and hence maximum Joule losses are decreased by 50%. It is then possible to provide a simpler and less expensive cooling system for the same level of performance.

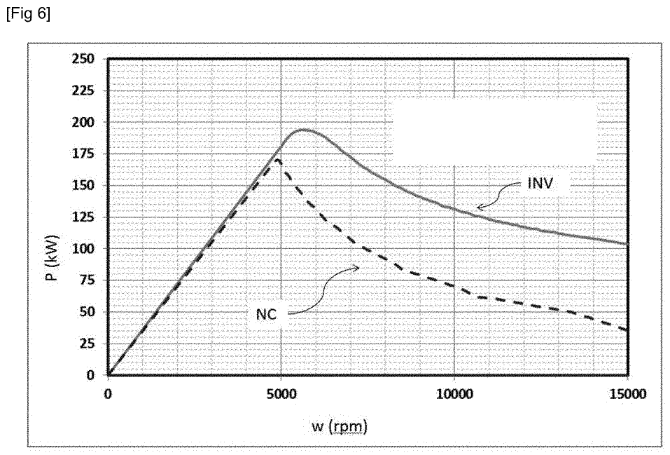

FIG. 6 is a curve of the power P in kW with rotational speed w of the rotor in rpm, for the electrical machine according to the invention INV and for the electrical machine which is not in accordance with the invention NC with a smaller adjusted current I for the invention INV adjusted so as to have the same low-speed torque.

It can be seen in FIG. 6 that it is possible to obtain an electrical machine with the same initial torque but with greater power at high speed while minimizing Joule losses.

1.-14. (canceled)

15. A rotor for an electrical machine comprising:
a rotor body, formed by a stack of laminations, placed on a rotor shaft;
N pairs of magnetic poles with each magnetic pole including at least three magnets which are positioned in axial voids; and
three asymmetric flux barriers which form each magnetic pole, which include one outer flux barrier, one center flux barrier and one inner flux barrier, each flux barrier comprising two inclined voids that are positioned on either side of each axial void, the two inclined voids forming an opening angle between them which corresponds to an angle between two straight lines each passing through the center of the rotor and through a midpoint positioned on an outer face of the respective voids of each flux barrier; and wherein
the rotor comprises:
magnets in the inclined voids of at least one flux barrier of each magnetic pole;
N primary magnetic poles which each includes an inner flux barrier comprising an opening angle, a center flux barrier comprising an opening angle and an outer flux barrier comprising an opening angle with the opening angles satisfying at least two of the following three equations: θ1=(0.946+/0.014)×P, θ2=(0.711+/0.014)×P, θ3=(0.508+/0.014)×P; and
N secondary magnetic poles each composed of an inner flux barrier comprising an opening angle, a center flux barrier comprising an opening angle and an outer flux barrier comprising an opening angle, such that the opening angles satisfy at least two of the following three equations: θ1=(0.776+/0.014)×P, θ2=(0.564+10.014)×P, θ3=(0.348+/0.014)×P, each secondary pole alternating with a primary pole; and wherein
P is the pole pitch of rotor defined in degrees by
$$P = \frac{360}{2 \times N} .$$

16. A rotor according to claim 15, wherein the number N of pairs of magnetic poles is between 2 and 9.

17. A rotor according to claim 16, wherein the N of pairs of magnetic poles is between 3 and 6.

18. A rotor according to claim 17, wherein the N pairs is equal to 5.

19. A rotor according to claim 15, wherein the flux barriers are shaped as a flat-bottomed V.

20. A rotor according to claim 15, wherein the rotor comprises magnets in the inclined voids of the inner and center flux barriers.

21. A rotor according to claim 20, wherein dimensions of the magnets in the inclined voids of the center flux barriers are identical to dimensions of the magnets in the outer axial voids.

22. A rotor according to claim 20, wherein dimensions of the magnets in the inclined voids of the inner flux barriers are identical to dimensions of the magnets in the center axial voids.

23. A rotor according to claim 15, wherein the opening angles of the primary magnetic poles satisfy at least two of the following three equations: θ1=(0.946+/0.008)×P, θ2=(0.711+/0.008)×P, θ3=(0.348+/0.008)×P.

24. A rotor according to claim 15, wherein the opening angles of the secondary magnetic poles satisfy at least two of the following three equations: θ1=(0.776+/0.008)×P, θ2=(0.564+10.008)×P, θ3=(0.348+/0.008)×P.

25. A rotor according to claim 15, wherein the opening angles of the primary magnetic poles satisfy all three equations.

26. A rotor according to claim 15, wherein the opening angles of the secondary magnetic poles satisfy all three equations.

27. An electrical machine, comprising a stator and a rotor according to claim 15, wherein the rotor is housed inside a stator.

28. An electrical machine according to claim 27, wherein the stator comprises radial slots positioned circumferentially around the stator, with a number of the slots being six times the number N of pole pairs of the rotor.

29. An electrical machine according to claim 28, wherein the slots extend axially along the stator.

30. An electrical machine according to claim 27, wherein the electrical machine is a synchronous reluctance electrical machine.

31. An electrical machine according to claim 30, wherein the stator comprises radial slots positioned circumferentially around the stator, with a number of the slots being six times the number N of pole pairs of the rotor.

32. An electrical machine according to claim 30, wherein the slots extend axially along the stator.
